(19) United States
(12) Patent Application Publication
(10) Pub. No.: US 2014/0218958 A1
(43) Pub. Date: Aug. 7, 2014

(54) UNIFORM ILLUMINATION LIGHT DIFFUSING FIBER

(71) Applicant: Corning Incorporated, Corning, NY (US)

(72) Inventors: Edward John Fewkes, Corning, NY (US); Stephan Lvovich Logunov, Corning, NY (US); Paul John Shustack, Elmira, NY (US)

(21) Appl. No.: 13/838,670

(22) Filed: Mar. 15, 2013

Related U.S. Application Data
(60) Provisional application No. 61/760,415, filed on Feb. 4, 2013.

(51) Int. Cl. F21V 8/00; C03C 25/10

(52) U.S. Cl. CPC G02B 6/0005; C03C 25/104
USPC 362/558; 65/443

(57) ABSTRACT

Light diffusing optical fibers for use in ultraviolet illumination applications and which have a uniform intensity that is angularly independent are disclosed herein along with methods for making such fibers. The light diffusing fibers are composed of a silica-based glass core that is coated with a number of layers including a scattering layer. According to some embodiments multiple light diffusing fibers are bundle together and are situated inside a jacket. The jacket may incorporate scattering sites, or may include a scattering layer situated thereon.

### CROSS-REFERENCE TO RELATED APPLICATION

This application claims the benefit of priority under 35 U.S.C. §119 of U.S. Provisional Application Ser. No. 61/760415 filed on Feb. 4, 2013 the content of which is relied upon and incorporated herein by reference in its entirety.

### FIELD

The present specification generally related to light diffusing optical fibers for use in illumination applications, and, more specifically, to light diffusing optical fibers which have a uniform color gradient that is angularly independent and are usable for efficiently diffusing light. Methods for making such fibers are also disclosed herein.

### BACKGROUND

It has been found that optical fibers that allow for propagation of light radially outwards along the length of the fiber, thereby illuminating the fiber, are particularly useful for a number of applications, such as special lighting, photochemistry, and for use in electronics and display devices. However, there are a number of issues with the current design of light diffusing fibers (“LDF”). One of the issues with the current design is that the angular distribution of different light colors from the fiber may vary depending on the viewing angle. Accordingly, there is a need for alternative light diffusing fiber designs that cure these deficiencies.

### SUMMARY

A first embodiment comprises a light diffusing fiber for emitting visible or near IR radiation comprising: a core comprising a silica-based glass comprising scattering defects; a cladding in direct contact with the core; and a scattering layer in direct contact with the cladding; wherein the intensity of the emitted ultraviolet radiation does not vary by more than about 30% for all viewing angle from about 10° to about 170° relative to the direction of the light diffusing optical fiber. In some embodiments the light diffusing optical fiber emits light having an intensity along the fiber that does not vary by more than about 20%. In some embodiments, the scattering induced attenuation loss comprises from about 0.1 dB/m to about 50 dB/m at a wavelength from about 400 nm to about 1700 nm

Another embodiment comprises a light diffusing fiber for emitting visible or near IR radiation including: a core comprising a silica-based glass comprising scattering defects; a cladding in direct contact with the core; and a scattering layer in surrounding the cladding with the cladding; wherein the intensity of the emitted ultraviolet radiation does not vary by more than about 30% for all viewing angle from about 10° to about 170° relative to the direction of the light diffusing optical fiber. In some embodiments the light diffusing optical fiber emits light having an intensity along the fiber that does not vary by more than about 20%. In some embodiments, the scattering induced attenuation loss comprises from about 0.1 dB/m to about 50 dB/m at a wavelength from about 400 nm to about 1700 nm.

In some embodiments, the core comprises a plurality of randomly distributed voids. In some embodiments, the cladding comprises a polymer. In some embodiments, the cladding comprises CPC6 material. In some embodiments, the scattering layer comprises a polymer. In some embodiments, the scattering layer comprises nano-to-microscale voids or microparticles or nanoparticles of a scattering material with refractive index contrast from base polymer more than 0.05 (i.e., the difference in refractive indices between polymer base and the scattering material is greater than 0.05) in refractive index. In some embodiments, the microparticles or nanoparticles comprise TiO2, SiO₂, Zr, Alumina, gas voids and others light scattering materials.

In some embodiments, the light diffusing fiber further comprises a light emitting device (light source) that emits light with a wavelength from about 400 nm to about 2000 (or 450 to or 1700 nm) into the core of the light diffusing fiber. In some embodiments, the light diffusing fiber further comprises a secondary layer in between the cladding and scattering layer.

In some embodiments there is no separate secondary layer and scattering layer is a polymer based layer with a plurality of randomly distributed voids also serves the function of the a secondary layer i.e.—it provides additional mechanical protection for the fiber

In some embodiments the individual fibers don't have the scattering layer, but the light diffusing fiber are bundled together forming fiber bundles and/or fiber ribbons that have an outer jacket and the scattering material is incorporated into the outer jacket or in the material surrounding the fibers within this outer jacket. Advantageously, such fiber bundles may be utilized he bundles are used with LED light sources that do not efficiently couple to a single fiber.

Another embodiment comprises a method of producing a light diffusing fiber comprising: forming an optical fiber preform comprising a preform core; drawing the optical fiber preform into an optical fiber; coating the optical fiber with at least one cladding layer; and coating the optical fiber with at least one scattering layer.

Another embodiment comprises a method making fiber bundles or ribbons comprising: producing light diffusing fibers, bundling the light diffusing fiber into fiber bundle with fiber bundle jacket, wherein the fiber bundle jacket has scattering material.

The fiber bundle jacket material can be made from thermoplastic, extrusion-grade polymers like, but not limited to, acrylic, polycarbonate, polystyrene, polyester, CPVC, styrene maleic anhydride, cyclic olefin, fluoropolymers, polylactic acid, polyurethane, ethylene vinyl acetate, polyolefin, polyamide, polysilicone, and ABS (acrylonitrile-butadiene-styrene). Scattering agents can be added to these polymers and then extruded as jacket materials for LDF's.

According to some embodiment an illumination system that comprises:
(i) at least one light diffusing fiber for emitting visible and/or near IR radiation comprising:

a. a core comprising a silica-based glass comprising scattering defects;

b. a cladding in direct contact with the core; and
(ii) a jacket surrounding said fiber,
   wherein multiple scattering sites are situated in at least one of (a) a scattering layer surrounding the jacket; (b) within the jacket material; (c) between the jacket and the light scattering fiber, and

wherein the intensity of the emitted radiation does not vary by more than about 30% for all viewing angle from about 10° to about 170° relative to the direction of the light diffusing optical fiber. According to some embodiments the jacket surrounds only one light diffusing fiber. According to other embodiments the jacket surround a multiple light diffusing fibers.

### BRIEF DESCRIPTION OF THE DRAWINGS

FIGS. 1A and 1B illustrate schematically two cross-sections an embodiment of light diffusing fiber (LDF).

FIGS. 1C through 1D are schematic illustrations of several other embodiments of light diffusing fibers

FIGS. 2A and 2B illustrate schematically another embodiment of light diffusing fiber.

FIGS. 2C illustrates schematically another embodiment, in this embodiment the light diffusing fiber does not scattering layer situated on the fiber, but utilizes a scattering layer situated on a fiber jacket.

FIG. 2D illustrates schematically an embodiment of light diffusing fiber where scattering material is distributed throughout the wall thickness of the jacket.

FIG. 2E illustrates schematically an embodiment of light diffusing fiber, where scattering sites are situated in an space between the fiber and a jacket.

FIG. 2F illustrates another embodiment of light diffusing fiber.

FIG. 3A illustrates schematically a LDF bundle with a transparent jacket surrounding and holding the multiple fibers, and the air gap in between.

FIGS. 3B through FIG. 3E illustrates schematically several embodiments of fiber optic bundles that include multiple light diffusing fibers.

FIG. 4 illustrates angular distribution of diffused light of one exemplary embodiment (d) of light diffusing fiber with scattering layer, and that of comparative fiber (e) without the without scattering layer for 500 nm wavelength.

### DETAILED DESCRIPTION

The present disclosure is provided as an enabling teaching and can be understood more readily by reference to the following description, drawings, examples, and claims. To this end, those skilled in the relevant art will recognize and appreciate that many changes can be made to the various aspects of the embodiments described herein, while still obtaining the beneficial results. It will also be apparent that some of the desired benefits of the present embodiments can be obtained by selecting some of the features without utilizing other features. Accordingly, those who work in the art will recognize that many modifications and adaptations are possible and can even be desirable in certain circumstances and are a part of the present disclosure. Therefore, it is to be understood that this disclosure is not limited to the specific compositions, articles, devices, and methods disclosed unless otherwise specified. It is also to be understood that the terminology used herein is for the purpose of describing particular aspects only and is not intended to be limiting.

Disclosed are materials, compounds, compositions, and components that can be used for, can be used in conjunction with, can be used in preparation for, or are embodiments of the disclosed method and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. Thus, if a class of substituents A, B, and/or C are disclosed as well as a class of substituents D, E, and/or F, and an example of a combination embodiment, A-D is disclosed, then each is individually and collectively contemplated. Thus, in this example, each of the combinations A-E, A-F, B-D, B-E, B-F, C-D, C-E, and C-F are specifically contemplated and should be considered disclosed from disclosure of A, B, and/or C; D, E, and/or F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and/or C; D, E, and/or F; and the example combination A-D. This concept applies to all aspects of this disclosure including, but not limited to any components of the compositions and steps in methods of making and using the disclosed compositions. Thus, if there are a variety of additional steps that can be performed it is understood that each of these additional steps can be performed with any specific embodiment or combination of embodiments of the disclosed methods, and that each such combination is specifically contemplated and should be considered disclosed.

In this specification and in the claims which follow, reference will be made to a number of terms which shall be defined to have the following meanings:

“Include,” “includes,” or like terms means encompassing but not limited to, that is, inclusive and not exclusive.

The term “about” references all terms in the range unless otherwise stated. For example, about 1, 2, or 3 is equivalent to about 1, about 2, or about 3, and further comprises from about 1-3, from about 1-2, and from about 2-3. Specific and preferred values disclosed for compositions, components, ingredients, additives, and like aspects, and ranges thereof, are for illustration only; they do not exclude other defined values or other values within defined ranges. The compositions and methods of the disclosure include those having any value or any combination of the values, specific values, more specific values, and preferred values described herein.

The indefinite article “a” or “an” and its corresponding definite article “the” as used herein means at least one, or one or more, unless specified otherwise.

### Light Diffusing Fibers

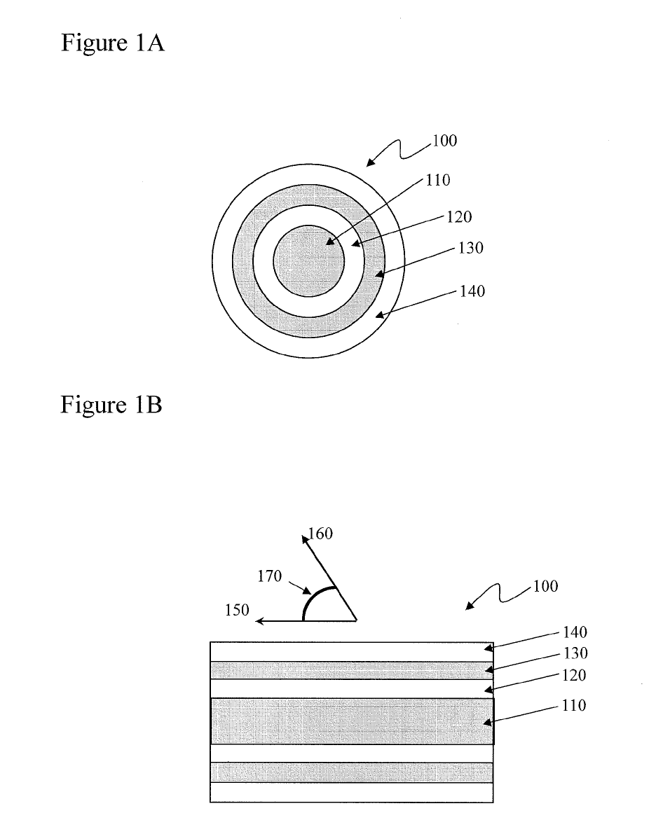

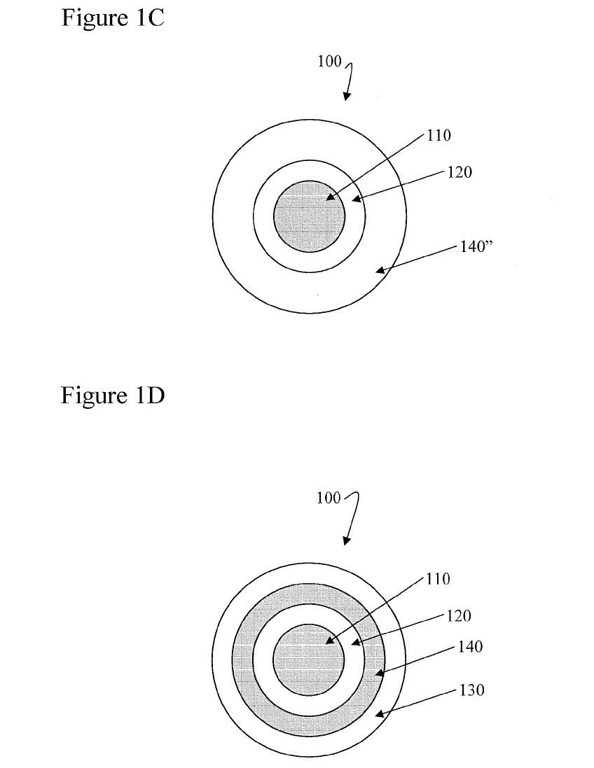

In typical light diffusing fibers, the dominant component of scattering is at low angles, close to 5-10 degrees, (referencing angle 170 in FIG. 1B). Therefore, light escapes from fiber core, and the intensity of light diffused out of the outer surface of such fiber depends on viewing angle 170 (FIG. 1B). In addition, scattered light from glass core of typical light diffusing fibers may be partially be captured by the polymer coating material surrounding such fiber, thus causing light attenuation due to absorption. However, the embodiments of the present invention disclosed herein solve these problems by homogenizing the scattered light produced by the light diffusing fibers 100 to provide light that is uniform in intensity, as a function of viewing angle.

A first aspect comprises a light diffusing fiber comprising a layer of scattering particles that provides uniform output (uniform intensity) as a function of viewing angle. The desire is to produce a uniform intensity output from the light diffusing fiber.

The desire is to produce a uniform output from the light diffusing fiber. Such fibers could be used as replacement for other conventional lighting objects, but have the additional advantages of: (i) being much thinner than conventional light sources, and therefore could be used with thin illuminating substrates; and/or (ii) being able to function as a cool light source—i.e., the light diffusing fiber does not heat up while producing the required illumination—this feature is advantageous when the fibers 100, or fiber bundles or fiber ribbons containing such fibers are used in environments that have to stay cold, or in the areas where they are used as a light source that is easily accessible to children or others, without a treat of potentially burning someone when handled directly.

Referring now to FIG. 1A and 1B, one embodiment of a light diffusing optical fiber 100 is schematically depicted. The light diffusing optical fiber 100 generally comprises a core 110, which further comprises a scattering region. The scattering region may comprise gas filled voids, such as shown in U.S. application Ser. Nos. 12/950,045, 13/097,208, and 13/269,055, herein incorporated by reference, or may comprise the inclusion of scattering particles, such as micro- or nanoparticles of ceramic materials, into the fiber core.

For example, the gas filled voids may occur throughout the fiber core 110, or may occur near the interface of the core and cladding 120, or may occur in an annular ring within the core. The gas filled voids may be arranged in a random or organized pattern and may run parallel to the length of the fiber or may be helical (i.e., rotating along the long axis of the fiber). The scattering region may comprise a large number of gas filled voids, for example more than 50, more than 100, or more than 200 voids in the cross section of the fiber. The gas filled voids may contain, for example, SO₂, Kr, Ar, CO₂, N₂, O₂, or mixtures thereof. The cross-sectional size (e.g., diameter) of the voids (or other scattering particles) may be from about 10 nm to about 10 μm and the length may vary from about 1 μm to about 50 m. In some embodiments, the cross sectional size of the voids (or other scattering particles) is about 10 nm, 20 nm, 30 nm, 40 nm, 50 nm, 60 nm, 70 nm, 80 nm, 90 nm, 100 nm, 120 nm, 140 nm, 160 nm, 180 nm, 200 nm, 250 nm, 300 nm, 400 nm, 500 nm, 600 nm, 700 nm, 800 nm, 1 μm, 2 μm, 3 μm, 4 μm, 5 μm, 6 μm, 7 μm, 8 μm, 9 μm, or 10 μm. In some embodiments, the length of the voids is about 1 μm, 2 μm, 3 μm, 4 μm, 5 μm, 6 μm, 7 μm, 8 μm, 9 μm, 10 μm, 20 μm, 30 μm, 40 μm, 50 μm, 60 μm, 70 μm, 80 μm, 90 μm, 100 μm, 200 μm, 300 μm, 400 μm, 500 μm, 600 μm, 700 μm, 800 μm, 900 μm, 1000 μm, 5 mm, 10 mm, 50 mm, 100 mm, 500 mm, 1 m, 5 m, 10 m, 20 m, or 50 m.

More specifically, FIGS. 1A and 1B illustrate schematically an embodiment of light diffusing fiber (LDF) 100 with a modified coating 140 for providing uniform scattering in both. The light diffusing fiber of this embodiment includes a glass core 110 with a plurality of light scattering nanostructures (gas filled voids), a polymer cladding 120, and a secondary coating 130.

In the embodiment shown in FIGS. 1A and 1B, the core portion 110 comprises silica-based glass and has an index of refraction, n. In some embodiments, the index of refraction for the core is about 1.458. The core portion 110 may have a radius of from about 10 μm to about 600 μm. In some embodiment the radius of the core is from about 30 μm to about 400 μm. In other embodiments, the radius of the core is about 125 μm to about 300 μm. In still other embodiments, the radius of the core is about 50 μm, 60 μm, 70 μm, 80 μm, 90 μm, 100 μm, 120 μm, 140 μm, 160 μm, 180 μm, 200 μm, 220 μm, 240 μm, or 250 μm.

The scattering particles and/or voids in the core 110 are utilized to scatter light propagating in the core of the light diffusing optical fiber 100 such that the light is directed radially outward from the core portion 110, thereby illuminating the light diffusing optical fiber and the space surrounding the light diffusing optical fiber. For example, the scatter-induced attenuation may be increased through increasing the concentration of voids (or other scattering objects), positioning voids (or other scattering objects) throughout the fiber 100, or in cases where the position of the voids (or other scattering objects) are limited to an annular ring, increasing the width of the annulus comprising the voids will also increase the scattering-induced attenuation for the same density of voids. Additionally, in compositions where the voids are helical, the scattering-induced attenuation may also be increased by varying the pitch of the helical voids over the length of the fiber. Specifically, it has been found that helical voids with a smaller pitch scatter more light than helical voids with a larger pitch. Accordingly, the intensity of the illumination of the fiber along its axial length can be controlled (i.e., predetermined) by varying the pitch of the helical voids along the axial length. The pitch of the helical voids, as used herein, refers to the inverse of the number times the helical voids are wrapped or rotated around the long axis of the fiber per unit length.

Still referring to FIGS. 1A and 1B, the light diffusing optical fiber 100 may further comprise a cladding 120 which surrounds and is in direct contact with the core portion 110. The cladding 120 may be formed from a material which has a low refractive index in order to increase the numerical aperture (NA) of the light diffusing optical fiber 100. In some embodiments, the cladding has a refractive index (lower than that of the) of less than about 1.415, and preferably less than 1.35. For example, the numerical aperture of the light diffusing optical fiber 100 may be greater than about 0.3, and in some embodiments greater than about 0.4 or greater than 0.5. In one embodiment, the cladding 120 comprises a low index polymeric material such as UV or thermally curable fluoroacrylate, such as PC452 available from SSCP Co. Ltd 403-2, Moknae, Ansan, Kyunggi, Korea, or silicone. In other embodiments, the cladding comprises a urethane acrylate, such as CPC6, manufactured by DSM Desotech, Elgin, Ill. In still other embodiments the cladding 120 comprises a silica glass which is down-doped with a down-dopant, such as, for example, fluorine. In some embodiments, the cladding comprises a high modulus coating. The cladding 120 generally has an index of refraction which is less than the index of refraction of the core portion 110. In some embodiments, the cladding 120 is a low index polymer cladding with a relative refractive index that is negative relative to pure silica glass. For example, the relative refractive index of the cladding may be less than about −0.5% and in some embodiments less than −1%, relative to pure silica (which is considered to be at 0%).

The cladding 120 generally extends from the outer radius of the core portion 110. In some embodiments described herein, the radial width of the cladding is greater than about 10 μm, greater than about 20 μm, greater than about 50 μm or greater than about 70 μm. In some embodiments, the cladding has a thickness of about 10 μm, 20 μm, 30 μm, 40 μm, 50 μm, 60 μm, 70 μm, 80 μm, 90 μm, or 100 μm.

The light diffusing fiber 100 may also comprise a substantially clear layer corresponding to a secondary coating typical for all optical fibers for ease of mechanical handling. For example, FIGS. 1A and 1B illustrate the light diffusing optical fiber 100 that comprises a secondary coating layer 130 which surrounds and is in direct contact with the cladding 120. The secondary layer may be a polymer coating. In at least some embodiments, the coating layer 130 has a constant diameter along the length of the light diffusing optical fiber 100.

The optical fiber 100 includes a scattering layer or a scattering coating 140. The scattering (homogenizing) coating, or layer 140 may be situated on top of the secondary coating 130. In some embodiments the secondary coating layer and scattering layer may be combined into a single coating layer 140″, depending on how fiber is manufactured. This process is similar to post-draw ink application for optical fibers. However, it can be combined in one step in the draw, and in this case secondary coating is not needed and the scattering/homogenizing layer 140 may be applied directly on top of the cladding.

Referring again to FIGS. 1A and 1B, the layer 140 is a scattering (homogenizing) layer and may be a polymer coating. For example, the scattering layer 140 may comprise any liquid polymer or pre-polymer material into which the scattering agent could is added. It may be applied to the fiber as a liquid and then converted to a solid after application to the fiber. In some embodiments, the scattering layer 140 comprises a polymer coating such as an acrylate-based, such as CPC6, manufactured by DSM Desotech, Elgin, Ill, or silicone-based polymer further comprising a scattering material. (e.g., nano or micro structures or voids. In some embodiments, it is most efficient to blend the scattering agents into standard UV curable acrylate based optical fiber coatings, such as Corning's standard CPC6 secondary optical fiber coating this combining the function of both layers 130 and 140 into a single coating 140″ (FIG. 1C). For example, according to one embodiment, in order to make scattering blends, a concentrate is first made by mixing 30% by weight of the scattering agent TiO₂ into DSM 950-111 secondary CPC6 optical fiber coating and then passing the mix over a 3 roll mill. These concentrates are then either applied directly as coatings or were further diluted with DSM 950-111 to produce the desired scattering effect.

In another embodiment the locations of layers 140 and 130 may be switched (FIG. 1D).

In some embodiments, the scattering layer 140 may be utilized to enhance the distribution and/or the nature of the light emitted radially from the core portion 110 and passed through the optional cladding 120 and/or the optional layer 130. The scattering material may comprise nano or microparticles with an average diameter of from about 200 nm to about 5 μm. In some embodiments, the average diameter of the particles is about 200 nm, 300 nm, 400 nm, 500 nm, 600 nm, 700 nm, 800 nm, 900 nm, 1 μm, 2 μm, 3 μm, 4 μm, 5 μm. The concentration of the scattering particles may vary along the length of the fiber or may be constant and may be a weight percent sufficient to provide even scattering of the light while limiting overall attenuation. In some embodiments, the weight percentage of the scattering particles in the scattering layer comprises about 1%, 2%, 3%, 4%, 5%, 6%, 7%, 8%, 9%, 10%, 11%, 12%, 13%, 14%, 15%, 16%, 17%, 18%, 19%, 20%, 25%, 30%, 35%, 40%, 45%, or 50%. In some embodiments, the scattering layer comprises small particles of a scattering material which comprise a metal oxides or other high refractive index material, such as TiO₂, ZnO, SiO₂, or Zr. The scattering material may also comprise micro- or nanosized particles or voids of law refractive index, such as gas bubbles. The scattering layer 140 generally extends either from the outer radius of the cladding 120 or from the outer diameter of the coating layer 130. (See FIGS. 1A-1D) In some embodiments described herein, the radial width of the scattering layer 140 is greater than about 1 μm, 2 μm, 3 μm, 4 μm, 5 μm, 6 μm, 7 μm, 8 μm, 9 μm, 10 μm, 20 μm, 30 μm, 40 μm, 50 μm, 60 μm, 70 μm, 80 μm, 90 μm, or 100 μm.

In some embodiments, the scattering material may contain TiO₂-based particles, such as a white ink, which provides for an angle independent distribution of light scattered from the core portion 110 of the light diffusing optical fiber 100. In some embodiments, the scattering particles comprise a sublayer within the scattering layer. For example, in some embodiments, the particle sublayer may have a thickness of about 1 μm to about 5 μm. In other embodiments, the thickness of the particle layer and/or the concentration of the particles in the scattering layer may be varied along the axial length of the fiber so as to provide more uniform variation in the intensity of light scattered from the light diffusing optical fiber 100 at large angles (i.e., angles greater than about 15 degrees).

In some embodiments the scattering agent within the scattering layer 140 could be any scattering material that has a refractive index differential from the matrix of coating (i.e., e.g. from base polymer) material of more than 0.05 (e.g., the difference in refractive indices between polymer base and the scattering material is greater than 0.05). Preferably the difference in refractive indices between base material and the scattering material is at least 0.1. That is, the index of refraction of the scattering particles is preferably at least 0.1 larger than the index of refraction of the base material (e.g., of the polymer or other matrix material) 1 of the scattering layer 140. The scattering material(s) (also referred to as a scattering agent(s) herein) can be solid particles, liquid droplets, or gas bubbles. If, for example, the scattering material is solid particles, these solid scattering particles can be either organic or inorganic. If the scattering material is organic, the particles can be pigments, polymers, or any organic material that can be incorporated into the base matrix material as a powder. Scattering agents can also be generated in-situ, via crystallization and/or phase separation. Examples of these are, but not limited to, polyethylene, polypropylene, syndiotactic polystyrene, nylon, polyethylene terephthalate, polyketones, and polyurethanes where the urethane functional groups align and crystallize during solidification.

For example, during the cure or solidification of the matrix material, one can form crystals that function as light scattering sites. Also for example, one can choose matrix materials, such that the material mixture in the matrix becomes incompatible during cure or solidification, causing it to phase separate into droplets or particles that can scatter light, and thus form scattering sites. Example of these would be, but are not limited to, styrene-butadiene-styrene block copolymers, polymethyl methacrylate in polystyrene, and acrylonitrile-butadiene-styrene.

If the scattering material is inorganic, the scattering particles can be, for example, pigments, oxides, or mineral fillers. Both the organics and inorganicse scattering particles can be generated, for example, from grinding a solid, or as small particles initially (, for example, from emulsion polymerization or solgels). Preferably the solid scattering particles (or scattering agents) are the inorganic oxides like silica, alumina, zirconia, titania, cerium oxide, tin oxide, and antimony oxide. Ground glass, ceramics, or glass-ceramics can also be utilised as scattering agents. Ground silicates or mineral fillers like quartz, talc, mullite, cordierite, clay, nepheline syenite, calcium carbonate, aluminum trihydrate, barium sulfate, wallastonite, mica, feldspar, pyrophyllite, diatomite, perlite, and cristobalite can utilized in layer 140 as scattering particles, to provide the uniform angular illumination intensity of the diffused light.

The cross-sectional size of the scattering particles within the scattering layer 140 is 0.1λ to 10λ, where λ is the wavelength of light propagating through the light diffusing fiber 100. Preferably the cross-sectional size d of the scattering particles be greater than 0.2λ and less than 5λ≦d≦5 times, and more preferably between 0.5λ and to 2λ. The amount of scattering agent can vary from about 0.005% to 70% by weight, preferably 0.01 to 60% and most preferably 0.02 to 50%. In general, the thinner the scattering layer or scattering coating 140, the larger amount of scattering particles should to be present within that scattering layer.

Referring to FIG. 1B, in the embodiment shown, unscattered light propagates down the light diffusing fiber 100 from the source in the direction shown by arrow 150. Scattered light is shown exiting the light diffusing fiber as arrow 160 at an angle 170, which describes angular difference between the direction of the fiber and the direction of the scattered light when it leaves light diffusing fiber 100. In some embodiments, the visible, and/or near IR spectrum of of the light diffusing fiber 100 is independent of angle 170. In some embodiments, the intensities of the spectra when angle 170 is 15° and 150° are within ±30% as measured at the peak wavelength. In some embodiments, the intensities of the spectra when angle 170 is 15° and 150° are within ±20%, ±15%, ±10%, or ±5% as measured at the peak wavelength.

In some embodiments described herein the light diffusing optical fibers will generally have a length from about 0.15 m to about 100 m. In some embodiments, the light diffusing optical fibers, for example, have a length of about 100 m, 75 m, 50 m, 40 m, 30 m, 20 m, 10 m, 9 m, 8 m, 7 m, 6 m, 5 m, 4 m, 3 m, 2 m, 1 m, 0.75 m, 0.5 m, 0.25 m, 0.15 m, or 0.1 m.

Further, the light diffusing optical fibers (LDFs) 100 described herein have a scattering induced attenuation loss of greater than about 0.2 dB/m at a wavelength of 550 nm. For example, in some embodiments, the scattering induced attenuation loss may be greater than about 0.5 dB/m, 0.6 dB/m, 0.7 dB/m, 0.8 dB/m, 0.9 dB/m, 1 dB/m, 1.2 dB/m, 1.4 dB/m, 1.6 dB/m, 1.8 dB/m, 2.0 dB/m, 2.5 dB/m, 3.0 dB/m, 3.5 dB/m, or 4 dB/m, 5 dB/m, 6 dB/m, 7 dB/m, 8 dB/m, 9 dB/m, 10 dB/m, 20 dB/m, 30 dB/m, 40 dB/m, or 50 dB/m at 550 nm.

As described herein, the light diffusing fiber can be constructed to produce uniform illumination along the entire length of the fiber or uniform illumination along a segment of the fiber which is less than the entire length of the fiber. The phrase “uniform illumination,” as used herein, means that the intensity of light emitted from the light diffusing fiber does not vary by more than 25% over the specified length.

The fibers described herein may be formed utilizing various techniques. For example, the fiber core 110 can be made by any number of methods which incorporate voids or particles into the glass fiber. For example, methods for forming an optical fiber preform with voids are described in, for example, U.S. patent application Ser. No. 11/583,098, which is incorporated herein by reference. Additional methods of forming voids may be found in, for example, U.S. application Ser. Nos. 12/950,045, 13/097,208, and 13/269,055, herein incorporated by reference. Generally, the optical fiber is drawn from an optical fiber preform with a fiber take-up system and exits the draw furnace along a substantially vertical pathway. In some embodiments, the fiber is rotated as it drawn to produce helical voids along the long axis of the fiber. As the optical fiber exits the draw furnace, a non-contact flaw detector may be used to examine the optical fiber for damage and/or flaws that may have occurred during the manufacture of the optical fiber. Thereafter, the diameter of the optical fiber may be measured with non-contact sensor. As the optical fiber is drawn along the vertical pathway, the optical fiber may optionally be drawn through a cooling system which cools the optical fiber prior to the coatings being applied to the optical fiber.

After the optical fiber exits the draw furnace or optional cooling system, the optical fiber enters at least one coating system where one or more polymer layers (i.e., the polymeric cladding material, the scattering layer, and/or the phosphor layer) are applied to the optical fiber. As the optical fiber exits the coating system, the diameter of the optical fiber may be measured with non-contact sensor. Thereafter, a non-contact flaw detector is used to examine the optical fiber for damage and/or flaws in the coating that may have occurred during the manufacture of the optical fiber.

According to one embodiment a method of producing a light diffusing fiber comprises: forming an optical fiber preform comprising a preform core; drawing the optical fiber preform into an optical fiber; coating the optical fiber with at least one cladding layer; and coating the optical fiber with at least one scattering layer.

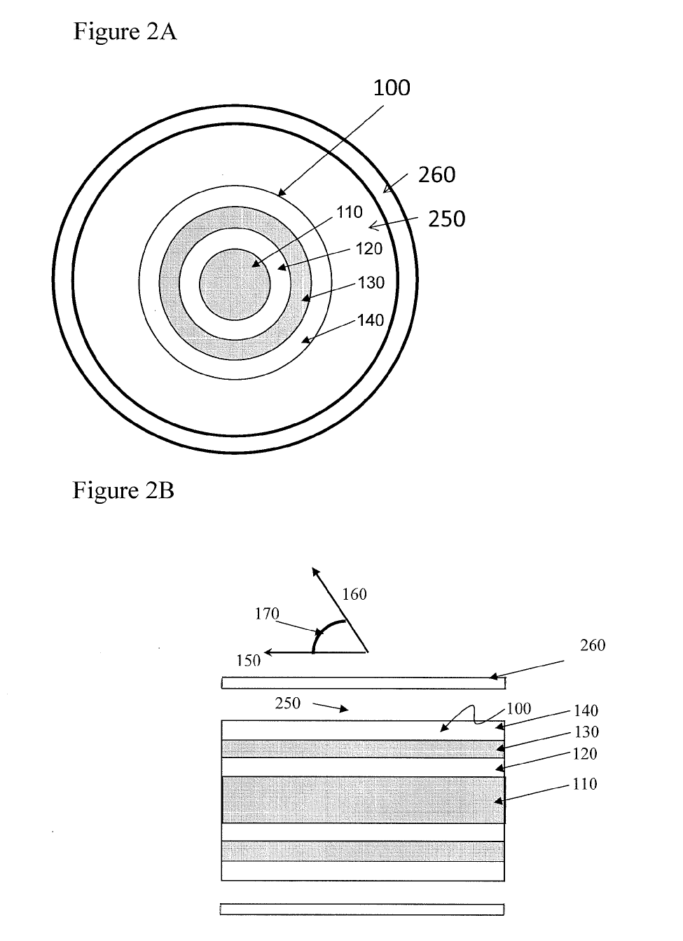

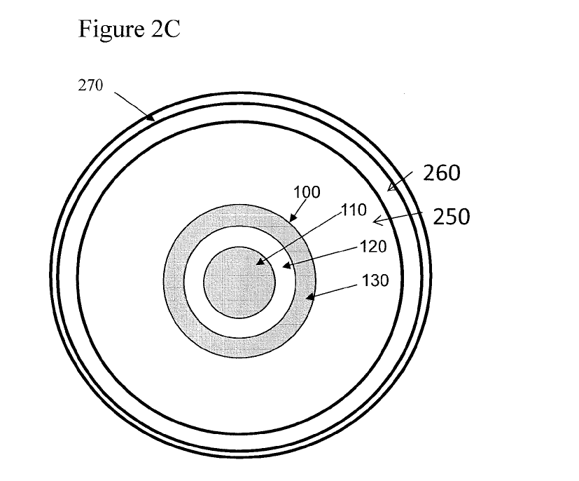

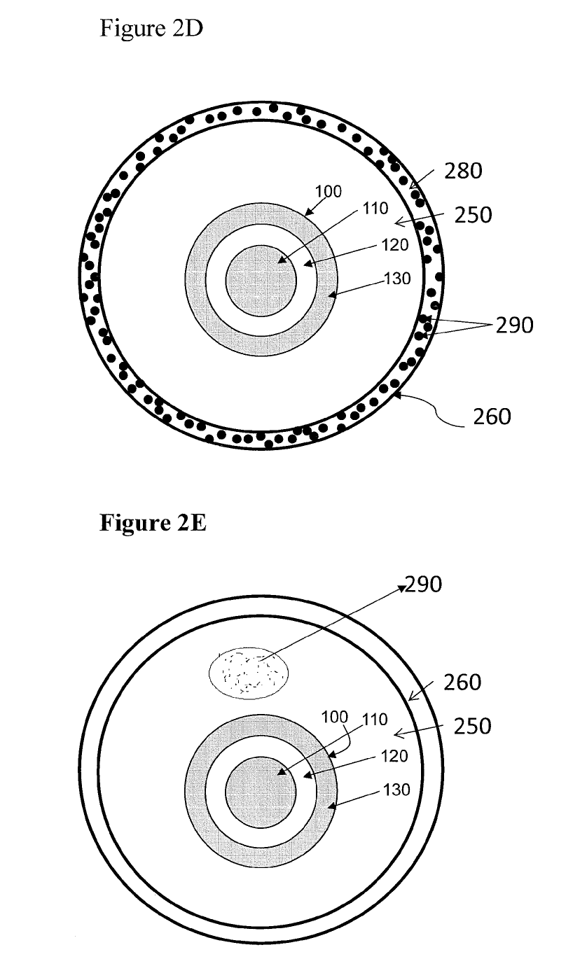

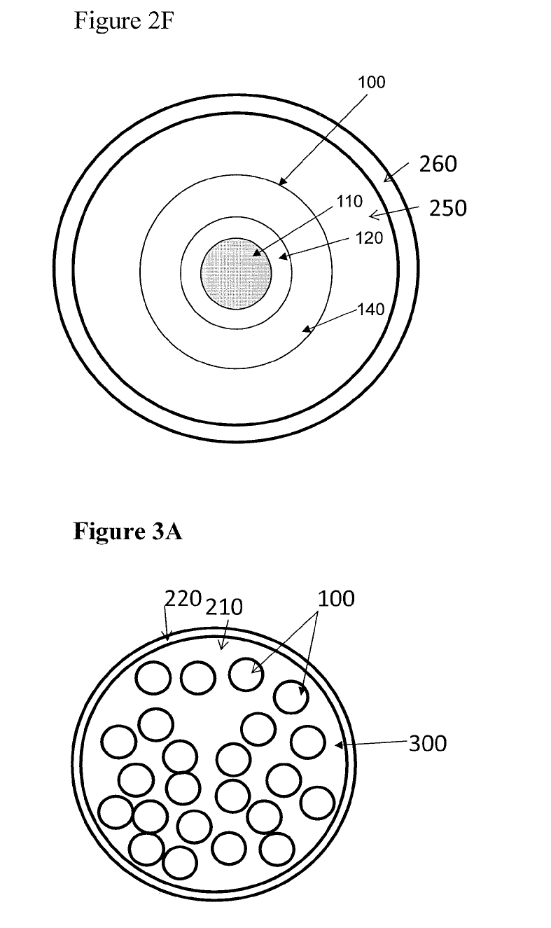

FIGS. 2A and 2B illustrate schematically an embodiment of light diffusing fiber (100) with nanostructures, a cladding 120, secondary coating 130, a clear or transparent jacket 260 surrounding the fiber 100, and an air gap or air space 250 situated inside the fiber jacket.

With reference to FIG. 2A, according to some embodiments the light diffusing fiber 100 may be enclosed in a transparent jacket 260 for ease of deployment and handling (i.e., to provide structural protection to otherwise fragile fibers). The fiber jacket 260 can be made from transparent PVC. The jacket material 280 is preferably clear, the jacket 260 being preferably 0.5-2 mm thick. In this embodiment, when the diffused light passes through the fiber jacket 260, the angular characteristics of scattered light will be similar to that provided by the diffused light that passed through the scattering layer 140.

Another embodiment includes light diffusing fiber 100 which doesn't have scattering layer 140 situated directly on the cladding or on another coating layer. Instead, in this embodiment, the scattering layer 270 is applied to the surface of the fiber jacket 260 (the scattering layer 270 may include scattering sites or particles 290 that are, for example, TiO₂, SiO₂, Alumina, Zr, SiO₂, combination thereof, or gas voids). This embodiment is illustrated, for example, in FIG. 2C.

Another embodiment included light diffusing fiber and jacket material where scattering sites 290 are distributed through the volume of the jacket's wall. (see FIG. 2D for example.)

Another embodiment includes light diffusing fiber and jacket 260, where scattering sites 290 are in form of powder are distributed between optical fiber and jacket wall, i.e., in space 250 (see FIG. 2E, for example).

FIG. 2B shows angular position/direction 160 of scattering light rays (at scattering angle 170) relative to propagation light direction 150.

As described above, in some embodiments there is no separate secondary coating layer, and the scattering layer is a polymer based layer, for example with a plurality of randomly distributed voids. This scattering layer also serves the function of the a secondary layer, i.e.,—it provides additional mechanical protection for the fiber.

In some embodiments the individual fibers don't have the scattering layer, but the light diffusing fiber are bundled together forming fiber bundles and/or fiber ribbons that have an outer jacket and the scattering material is incorporated into the outer jacket or in the material surrounding the fibers within this outer jacket. Advantageously, such fiber bundles may be utilized the bundles are used with LED light sources that do not efficiently couple to a single fiber.

### Fiber Bundles.

Another embodiment of the present invention comprises a fiber bundle with plurality of light diffusing fibers (LDFs) 100, (preferably 7 to 200 light diffusing fibers, more preferably 12 to 50) coupled to a light emitting diode, i.e., LED. LED is an extended source with size preferably exceeding size of the optical fiber and the numerical aperture (NA) exceeding that of the NA of the optical fiber—e.g., NA of 1.0 vs. NA of 0.5. In order to efficiently couple an light diffusing optical fibers to LED (with >60% efficiency) it is preferable to use plurality of these of light diffusing fibers 100 in a bundle of ribbon form. The number of the light diffusing optical fibers 100 in the bundle or ribbon can be from 7 to several thousand, with high efficiencies of light extraction at visible and optionally near infrared (IR) wavelengths. (As defined herein IR spectrum encompasses light situated in 800 nm to 2000 nm wavelength range). The plurality of light diffusing fibers 100 are combined into fiber bundle 300 with fiber bundle jacket 220 surrounding these fibers. The fiber bundle jacket 220 is preferably made of an optically transparent material or translucent material. The fiber bundles 300 may be advantageously utilized to provide efficient coupling to the extended light sources such as LED or light bulbs. For example, in some embodiments the light diffusing fibers 100 are situated loosely (i.e., the fibers can slide relative to one another) in a protective tube, such as transparent PVC tube. Thus, the bundle jacket 220, for example this tube, protects the fibers situated therein, while allowing them to move relative to one another.

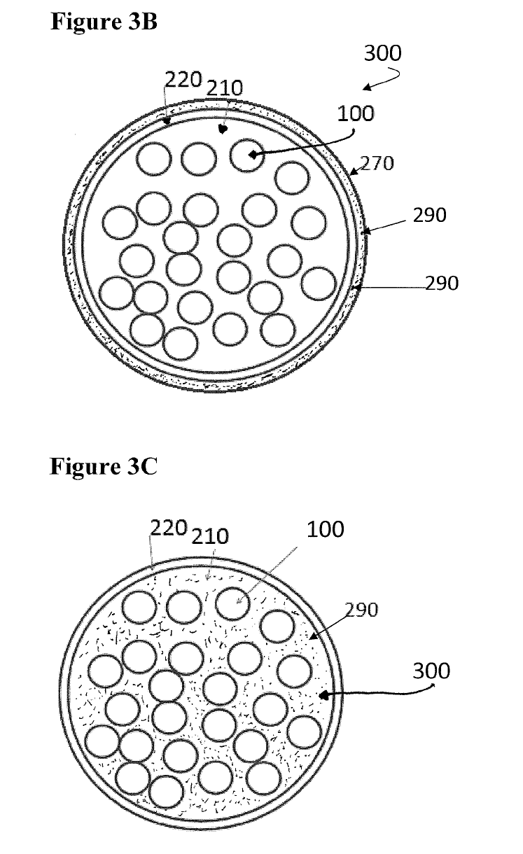

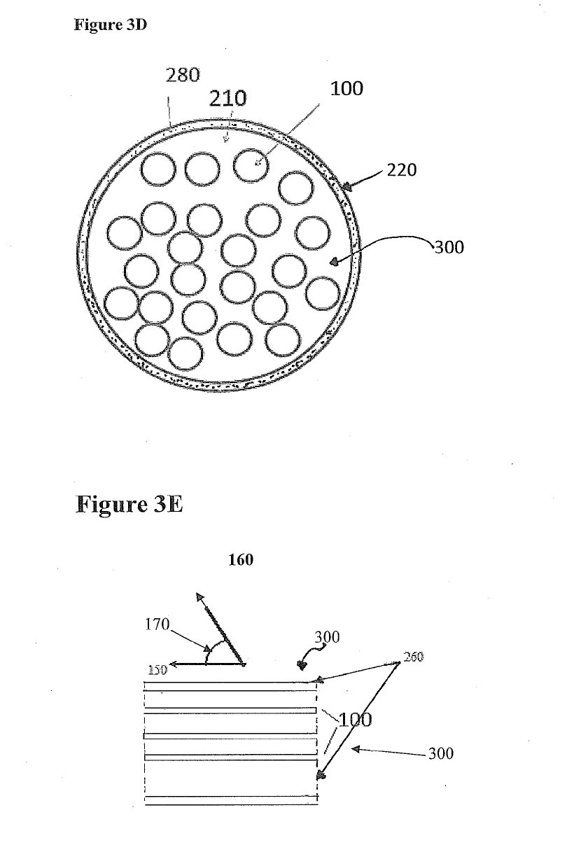

Various options of incorporating scattering sites can also provide angular emitted light uniformity similar to that provided the single fiber with clear jacket protection. In a one exemplary embodiment the scattering particles 290 (also referred to as scattering centers herein) comprise materials such as materials TiO₂, silica, alumina, gas voids, and/or Zr that are added to the multiple light diffusing fibers 100 (the scattering centers 290 can be present, for example, in a scattering coating(s) or layer(s) 140). As described above, these fibers are situated within the fiber bundle jacket 220. The light is scattered from the scattering coating or layer 140 without significant propagation through the length of scattering layer along the length of the fiber. (See, for example, FIG. 3A.) The scattered light from each light diffusing fiber 100 in the bundle is passed through transparent jacket material of the fiber bundle jacket 220, providing uniform illumination. In addition, multiple scattering events between the fibers 100 also take place in fiber bundles 300. These multiple scattering events between the fibers 100 provide even more uniform scattering pattern (more uniform illumination emitting from the fiber bundle 300) in comparison to that provided by a single light diffusing fiber 100. In this embodiment, the design of the fibers utilized in the bundle 300 is similar to the one shown in FIG. 1A. The light diffusing fibers 100 are be surrounded by the jacket 220, for example with air gap 210 at least partially separating fibers 100 from the inner wall of the jacket 220. In this embodiment, jacket 220 is clear—i.e., optically transparent at the operating/scattered wavelength(s).

The fiber bundle jacket material can be, for example, from thermoplastic, extrusion-grade polymers like, but not limited to, acrylic, polycarbonate, polystyrene, polyester, CPVC, styrene maleic anhydride, cyclic olefin, fluoropolymers, polylactic acid, polyurethane, ethylene vinyl acetate, polyolefin, polyamide, polysilicone, and ABS (acrylonitrile-butadiene-styrene). Scattering agents can be added to these polymers and then extruded as jacket materials for LDF's.

In some embodiments, the light diffusing fibers 100 forming bundle do not have the scattering layer 140. Instead, the scattering material such as TiO₂, SiO₂, Zr, alumina, or gas bubbles is applied to outer surface of jacket material 280 (e.g., PVC) of the jacket 220, for example as a scattering layer or coating 270 that is similar in composition to the coating 140. In one embodiment the scattering sites 290 are applied to the surface of the PVC material during thermal extrusion or in after bundling the fibers within the fiber bundle jacket. (See (FIG. 3C)

In another embodiment, the scattering sites such as such as TiO2, TiO₂, SiO₂, Zr, alumina, or gas bubbles are distributed through the wall of jacket material 280 (see FIG. 3D, for example) of jacket 220, which is 1-2 mm thick. The jacket material 280 may be, for example, a transparent or translucent PVP material. In some embodiments, the particles 290 comprise a layer within the scattering layer. For example, in some embodiments, the particle layer may have a thickness of about 1 μm to about 5 μm. In other embodiments, the thickness of the scattering layer 140 may be varied along the axial length of the fibers 100 so as to provide more uniform variation in the intensity of light scattered from the light diffusing optical fiber bundle 300 at large angles (i.e., angles greater than about 15 degrees).

In some embodiments (FIG. 3C) the scattering sites 290 may be in the form of scattering powder material that may be dispersed in the void space between fibers and jacket material. This powder can be TiO, SiO₂, alumina or Zr particles or any other small particles material with sizes less than 5 μm, for and more preferably less than 4 μm (for example ≦3 μmm or ≦2 μm).

Referring now to FIGS. 3A and 3B, one embodiment of a light diffusing optical fiber bundle 200 is schematically depicted. The bundle contains plurality of light diffusing optical fibers 100, which generally comprises a core, which further comprises a scattering region. The scattering region may comprise gas filled voids, such as shown in U.S. application Ser. Nos. 12/950,045, 13/097,208, and 13/269,055, herein incorporated by reference, or may comprise the inclusion of solid particles, such as micro- or nanoparticles, into the fiber core.

The gas filled voids may occur throughout the core, may occur near the interface of the core and cladding, or may occur as an annular ring within the core. The gas filled voids may be arranged in a random or organized pattern and may run parallel to the length of the fiber or may be helical (i.e., rotating along the long axis of the fiber). The scattering region may comprise a large number of gas filled voids, for example more than 50, more than 100, or more than 200 voids in the cross section of the fiber. The gas filled voids may contain, for example, SO₂, Kr, Ar, CO₂, N₂, O₂, or mixtures thereof The cross-sectional size (e.g., diameter) of the voids may be from about 10 nm to about 10 μm and the length may vary from about 1 μm to about 50 m. In some embodiments, the cross sectional size of the voids is about 10 nm, 20 nm, 30 nm, 40 nm, 50 nm, 60 nm, 70 nm, 80 nm, 90 nm, 100 nm, 120 nm, 140 nm, 160 nm, 180 nm, 200 nm, 250 nm, 300 nm, 400 nm, 500 nm, 600 nm, 700 nm, 800 nm, 1 μm, 2 μm, 3 μm, 4 μm, 5 μm, 6 μm, 7 μm, 8 μm, 9 μm, or 10 μm. In some embodiments, the length of the voids is about 1 μm, 2 μm, 3 μm, 4 μm, 5 μm, 6 μm, 7 μm, 8 μm, 9 μm, 10 μm, 20 μm, 30 μm, 40 μm, 50 μm, 60 μm, 70 μm, 80 μm, 90 μm, 100 μm, 200 μm, 300 μm, 400 μm, 500 μm, 600 μm, 700 μm, 800 μm, 900 μm, 1000 μm, 5 mm, 10 mm, 50 mm, 100 mm, 500 mm, 1 m, 5 m, 10 m, 20 m, or 50 m.

In the embodiment shown in FIGS. 1A-3D the core portion of the fiber 100 comprises silica-based glass and has an index of refraction, n. In some embodiments, the index of refraction for the core is about 1.458. The core portion may have a radius of from about 10 μm to about 600 μm. In some embodiment the radius of the core is from about 30 μm to about 400 μm. In other embodiments, the radius of the core is from about 125 μm to about 300 μm. In still other embodiments, the radius of the core is about 50 μm, 60 μm, 70 μm, 80 μm, 90 μm, 100 μm, 120 μm, 140 μm, 160 μm, 180 μm, 200 μm, 220 μm, 240 μm, or 250 μm.

The voids in the core of fiber 100 are utilized to scatter light propagating in the core of the light diffusing optical fiber 100 such that the light is directed radially outward from the core portion, thereby illuminating the light diffusing optical fiber and the space surrounding the light diffusing optical fiber. The scatter-induced attenuation may be increased through increasing the concentration of voids, positioning voids throughout the fiber, or in cases where the voids are limited to an annular ring, increasing the width of the annulus comprising the voids will also increase the scattering-induced attenuation for the same density of voids. Additionally, in compositions where the voids are helical, the scattering-induced attenuation may also be increased by varying the pitch of the helical voids over the length of the fiber. Specifically, it has been found that helical voids with a smaller pitch scatter more light than helical voids with a larger pitch. Accordingly, the intensity of the illumination of the fiber along its axial length can be controlled (i.e., predetermined) by varying the pitch of the helical voids along the axial length. The pitch of the helical voids, as used herein, refers to the inverse of the number times the helical voids are wrapped or rotated around the long axis of the fiber per unit length.

Still referring to FIGS. 3A, and 3C-3D, the light diffusing optical fiber 100 may further comprise a low refractive cladding which surrounds and is in direct contact with the core portion. In some embodiments, the cladding comprises a fluorine and boron co-doped glass. In some embodiments, the cladding comprises a polymer. The cladding may be formed from a material which has a low refractive index in order to increase the numerical aperture (NA) of the light diffusing optical fiber 100. In some embodiments, the cladding has a refractive index contrast (as compared to the core) of less than about 1.35. For example, the numerical aperture of the fiber may be greater than about 0.3, and in some embodiments, greater than about 0.5. In one embodiment, the cladding comprises a low index polymeric material such as UV or thermally curable fluoroacrylate, such as PC452 available from SSCP Co. Ltd 403-2, Moknae, Ansan, Kyunggi, Korea, or silicone. In other embodiments, the cladding comprises a urethane acrylate, such as CPC6, manufactured by DSM Desotech, Elgin, Ill. In other embodiments the cladding may be formed from silica glass which is down-doped with a down-dopant, such as, for example, fluorine and boron. The cladding generally has an index of refraction which is less than the index of refraction of the core portion. In some embodiments, the cladding is a low index polymer cladding with a relative refractive index that is negative relative to silica glass. For example, the relative refractive index of the cladding may be less than about −0.5% and in some embodiments less than −1%.

Referring to FIG. 3E, in the embodiment shown, unscattered light propagates down the light diffusing fibers 100 situated within the bundle 300 in the direction shown by arrow 150. Scattered light is shown exiting the diffusing fiber bundle 300 as arrow 160 at an angle 170, which describes angular difference between the axial direction of the fiber bundle 300 and the direction of the scattered light when it leaves light diffusing fiber bundle 300. In some embodiments, the visible- near IR spectrum of the light diffusing fiber bundle 300 is independent of angle 170. In some embodiments, the intensities of the spectra when angle 170 is 15° and 150° are within ±30% as measured at the peak wavelength. In some embodiments, the intensities of the spectra when angle 170 is 15° and 150° are within ±20%, ±15%, ±10%, or ±5% as measured at the peak wavelength. The illumination system may comprise a light emitting device that emits light with a wavelength from about 300 nm to about 450 nm into the core of the light diffusing fiber, but the light source may also operate in 400-2000 nm range (e.g., 450 to 1700 nm range). A coupling optics may be disposed between the light source (light emitting device, for example a laser or an LED) and the light diffusing optical fiber bundle 300.

In some embodiments described herein the light diffusing optical fiber bundle will generally have a length from about 100 m to about 0.15 m. In some embodiments, the light diffusing optical fibers will generally have a length of about 100 m, 75 m, 50 m, 40 m, 30 m, 20 m, 10 m, 9 m, 8 m, 7 m, 6 m, 5 m, 4 m, 3 m, 2 m, 1 m, 0.75 m, 0.5 m, 0.25 m, 0.15 m, or 0.1 m.

Further, the light diffusing optical fiber bundles described herein have a scattering induced attenuation loss of greater than about 0.2 dB/m at a wavelength of 400 to 1700 nm. For example, in some embodiments, the scattering induced attenuation loss may be greater than about 0.5 dB/m, 0.6 dB/m, 0.7 dB/m, 0.8 dB/m, 0.9 dB/m, 1 dB/m, 1.2 dB/m, 1.4 dB/m, 1.6 dB/m, 1.8 dB/m, 2.0 dB/m, 2.5 dB/m, 3.0 dB/m, 3.5 dB/m, 4 dB/m, 5 dB/m, 6 dB/m, 7 dB/m, 8 dB/m, 9 dB/m, 10 dB/m, 20 dB/m, 30 dB/m, 40 dB/m, or 50 dB/m at 400 nm, 500 nm, 6000 nm, 700 nm, 800 nm, 900 nm, 1000 nm, 1200 nm, 1400 nm, and 1600 nm o.

As described herein, the light diffusing fiber bundle may be constructed to produce uniform illumination along the entire length of the fiber bundle or uniform illumination along a segment of the fiber which is less than the entire length of the fiber. The phrase “uniform illumination,” as used herein, means that the intensity of light emitted from the light diffusing fiber bundle does not vary by more than 25%-30% over the specified length.

In some embodiments the scattering powder material may be disperced in the void space between light diffusing fibers 100 and jacket material. This powder can be TiO, SiO₂, alumina or Zr particles or any other small particles material with sizes <2-5 um

Accordingly, according to one embodiment,a method making fiber bundles or ribbons includes the steps of producing light diffusing fibers, bundling the light diffusing fiber into fiber bundle with fiber bundle jacket, wherein the fiber bundle jacket either includes scattering material(s), or is coated with a coating that includes scattering material(s)

### EXAMPLES

### Example 1

In this embodiment, a light diffusing fiber 100 comprises a silica core 110, a polymer cladding 120, a secondary coating 130 that is 30 μm thick, and a scattering layer 140 that is 2 μm thick. The scattering layer 140 comprises TiO₂ particles suspended in a polymer. The refractive index of the polymer material is 1.55, and the refractive index of the TiO₂ particles is about 2.5, so with the significant index mismatch and small size of silica particles (˜0.2 μm), one may achieve uniform scattering as a function of scattering angle relative to incident angle.

### Example 2

In this embodiment, a light diffusing fiber 100 comprises a silica core 110, a polymer cladding 120, and a 30 μm thick single layer 140 comprising typical materials utilized for the secondary coating layers with the scattering particles or sites situated therein.

### Example 3

In this embodiment, a light diffusing fiber 100 comprises a silica core 110, a polymer cladding 120, a secondary coating 130 that is 30 μm thick, and no scattering layer 140 situated directly on top of the secondary coating 130, but with a clear jacket 260 and a scattering layer 270 (also referred to herein as the scattering jacket coating layer) situated on the outer surface of the fiber jacket 260. The scattering coating layer 270 utilizes high efficient scattering particles, for example a white ink (TiO₂ based filled polymer). The TiO₂ particles are transparent at 400-1700 nm and suitable for visible near IR applications.

### Example 4

In this embodiment, a light diffusing fiber 100 comprises a silica core 110, a polymer cladding 120, a secondary coating 130. A clear jacket surrounds the fiber 100, and scattering powder is dispersed between fiber and the jacket The scattering powder uses high efficient scatters, such as any light non-absorbing material with sizes <2 μm.

### Example 5

In this embodiment, a fiber bundle 300 comprises 39 light diffusing fibers 100. Each of these fibers comprises a silica core, a polymer cladding, secondary coating 30 um thick, a scattering layer 2 μm thick, and clear transparent PVC jacket material. The scattering layer comprise TiO₂ particles in a polymer base.

### Example 6

In this embodiment, a fiber bundle 300 comprises 39 light diffusing fibers 100. Each of these fibers comprises a silica core, a polymer cladding, and a single 25 μm thick layer comprising both secondary coating material and the scattering particles, all enclosed within the clear transparent PVC jacket material. The scattering layer (i.e., the single 25 μm thick layer) may comprise, for example, TiO₂ particles in a polymer base

### Example 7

In this embodiment, a fiber bundle 300 comprises 39 light diffusing fibers 100. Each of these fibers comprises a silica core, a polymer cladding, secondary coating, and clear transparent PVC jacket material with scattering layer applied to the outside of the jacket material. The scattering layer includes TiO₂ particles in a polymer base.

In each of the examples 1-7, the thickness of each layer and concentration of the dopants was modified to obtain optimum spectrum and angular dependence. These exemplary designs provide fibers and fiber bundles with color uniform angular intensity from blue (445 nm) to red (650 nm) wavelength.

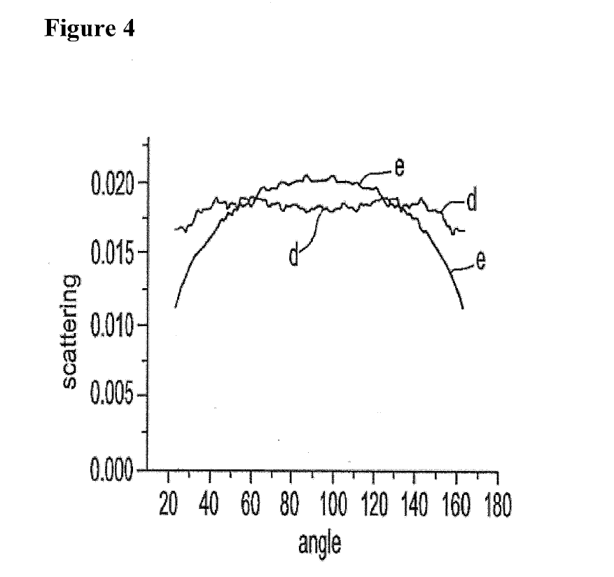

In one exemplary embodiment, the incident light coupled to the light diffusing fibers was in 445 nm to 650 nm wavelength range. The light diffusing fibers 100 contained random airlines (gas filled voids) as internal scattering sites. For the homogenizing coating 140, we utilized TiO₂ particles placed in the secondary coating. The results show that the angular distribution can change significantly (FIGS. 4). The fiber corresponding to FIG. 4 (curve d) comprises a random airline silica core, a polymer cladding and a scattering layer comprising TiO₂ particles with a scattering loss of ˜3 dB/m. As can be seen in FIG. 4, plot d shows that the light is broadly and uniformly scattered. The uniform distribution (d) of light shown in FIG. 4 is important for maximum distance coverage from surface of the fiber in broad range of applications.

We claim:

1. A light diffusing fiber for emitting visible and/or near IR radiation radiation comprising:
a. a core comprising a silica-based glass comprising scattering defects;
b. a cladding in direct contact with the core; and
c. a scattering layer surrounding and/or in direct contact with the cladding;
wherein the intensity of the emitted radiation does not vary by more than about 30% for all viewing angle from about 10° to about 170° relative to the direction of the light diffusing optical fiber.

2. The light diffusing fiber of claim 1, wherein the light diffusing optical fiber emits light having an intensity along the fiber that does not vary by more than about 20%.

3. The light diffusing fiber of claim 1, wherein the scattering induced attenuation loss comprises from about 0.1 dB/m to about 50 dB/m at the wavelengths situated in 450 nm to about 2000 nm range.

4. The light diffusing fiber of claim 1, wherein the core comprises a plurality of randomly distributed voids.

5. The light diffusing fiber of claim 1, wherein the cladding comprises a polymer.

6. The light diffusing fiber of claim 5, wherein the cladding comprises CPC6.

7. The light diffusing fiber of claim 1, wherein the scattering layer comprises a polymer.

8. The light diffusing fiber of claim 7, wherein the scattering layer comprises CPC6.

9. The light diffusing fiber of claim 1, wherein the scattering layer comprises nano- to microscale voids or microparticles or nanoparticles of a scattering material.

10. The light diffusing fiber of claim 9, wherein the microparticles or nanoparticles comprise SiO₂ or Zr.

11. The light diffusing fiber of claim 1, further comprising a secondary layer in between the cladding and scattering layer.

12. A method of producing the light diffusing fiber of claim 1 comprising:
a. forming an optical fiber preform comprising a preform core;
b. drawing the optical fiber preform into an optical fiber;
c. coating the optical fiber with at least one cladding layer; and
d. coating the optical fiber with at least one scattering layer.

13. A light diffusing optical fiber bundle comprising:
an optically transmissive jacket; and
a plurality of light diffusing optical fibers disposed within the optically transmissive jacket, wherein each of the plurality of light diffusing optical fibers includes a glass core including a plurality of nano-sized voids, and the plurality of light diffusing optical fibers extend along a length of the optically transmissive jacket and the optically transmissive jacket includes a scattering agent.

14. An illumination system comprising:
a light source for emitting light; and
a light diffusing optical fiber bundle optically coupled to the light source such that at least a portion of the emitted light enters the light diffusing optical fiber bundle, wherein the light diffusing optical fiber bundle includes:
an optically transmissive jacket; and
a plurality of light diffusing optical fibers disposed within the optically transmissive jacket, wherein each of the plurality of light diffusing optical fibers includes a glass core including a plurality of nano-sized voids, and the plurality of light diffusing optical fibers extend along a length of the optically transmissive jacket and the optically transmissive jacket includes a scattering agent.

15. The illumination system of claim 14, further comprising coupling optics disposed between the light source and the light diffusing optical fiber bundle.

16. An illumination system comprising;
(i) at least one light diffusing fiber for emitting visible and/or near IR radiation comprising:
a. a core comprising a silica-based glass comprising scattering defects;
b. a cladding in direct contact with the core; and
(ii) a jacket surrounding said at least one light diffusing fiber,
wherein multiple scattering sites are situated in at least one of (a) a scattering layer surrounding the jacket; (b) within the jacket material; (c) between the jacket and the at least one light diffusing fiber, and
wherein the intensity of the emitted radiation does not vary by more than about 30% for all viewing angle from about 10° to about 170° relative to the direction of the light diffusing optical fiber.

17. The illumination system of claim 16 wherein said jacket surrounds multiple light diffusing fibers.
